(19) United States
(12) Patent Application Publication
(10) Pub. No.: US 2008/0186303 A1
(43) Pub. Date: Aug. 7, 2008

(54) DISPLAY DRIVER IC HAVING EMBEDDED DRAM

(75) Inventor: Hiroyuki TAKAHASHI, Kawasaki (JP)

Correspondence Address: YOUNG & THOMPSON, 209 Madison Street, Suite 500, ALEXANDRIA, VA, 22314, US

(73) Assignee: NEC ELECTRONICS CORPORATION, KAWASAKI (JP)

(21) Appl. No.: 11/971,219

(22) Filed: Jan. 9, 2008

(30) Foreign Application Priority Data
Feb. 6, 2007 (JP) 2007-026431

(51) Int. Cl. G06F 3/038

(52) U.S. Cl. 345/212

(57) ABSTRACT

A display driver IC for controlling display of an image on a display panel is provided with a DRAM, a power supply circuit and a driver circuit. Digital data corresponding to the image is stored in the DRAM. The power supply circuit generates a predetermined voltage. The driver circuit converts the digital data into a gray-scale voltage by using the predetermined voltage and outputs the gray-scale voltage to the display panel. Electric power is supplied to the DRAM from the power supply circuit.

### INCORPORATION BY REFERENCE

This application is based upon and claims the benefit of priority from Japanese patent application No. 2007-026431, filed on Feb. 6, 2007, the disclosure of which is incorporated herein in its entirely by reference.

### BACKGROUND OF THE INVENTION

1. Field of the Invention

The present invention relates to a display driver IC (Integrated Circuit) for controlling display of an image on a display panel. In particular, the present invention relates to a display driver IC having an embedded DRAM (Dynamic Random Access Memory).

2. Description of Related Art

A liquid crystal display (LCD) is known as a kind of image display apparatuses. The liquid crystal display is provided with an LCD panel on which an image is displayed and an LCD driver IC that is an IC chip for controlling the image display. The LCD driver IC converts digital data (display data) corresponding to the image into gray-scale voltages, and applies the gray-scale voltages to pixels of the LCD panel. As a result, the image is displayed on the LCD panel.

In general, an SRAM (Static RAM) is used as a memory for storing the display data. The SRAM may be provided separately from the LCD driver IC or may be provided within the LCD driver IC. In the case where the SRAM is provided within the LCD driver IC, the SRAM is specifically called an “embedded SRAM (eSRAM)”.

Japanese Laid-Open Patent Application No. JP-P2002-56668 discloses an LCD driver IC in which the embedded SRAM is replaced with an embedded DRAM (eDRAM). A memory cell of a DRAM is smaller than a memory cell of an SRAM. Therefore, it is considered possible to reduce a chip area of the LCD driver IC by replacing the embedded SRAM with the embedded DRAM.

FIG. 1 shows a configuration of a typical DRAM 10 and kinds of voltages used therein. The DRAM 10 includes a memory cell 11, a pre-charge circuit 12, and a sense amplifier 13. The memory cell 11 is comprised of a cell transistor and a cell capacitor. A gate terminal of the cell transistor is connected to a word line WL. One of a source and a drain of the cell transistor is connected to a bit line BL, while the other is connected to one end of the cell capacitor. The pre-charge circuit 12 is a circuit for pre-charging a pair of complementary bit lines BL, /BL to a pre-charge voltage, which is comprised of transistors for setting. A gate terminal of the transistor for setting is connected to a pre-charge line PDL. The sense amplifier 13 senses a data stored in the memory cell 11, based on voltages appearing on the pair of complementary bit lines BL and /BL.

A voltage VPP (3.0 V) or a voltage VKK (−0.3 V) is applied to the word line WL, depending on ON/OFF state. A voltage VBB (−0.5 V) is a substrate voltage that is applied to a back gate of the cell transistor in a standby mode. These negative voltages VKK and VBB are applied for the purpose of reducing an off-leakage current. A voltage HVDD (0.75 V: half a power supply voltage VDD (1.5 V)) may be applied to the other end of the cell capacitor in some cases. A voltage VPP2 (2.0 V) or a ground voltage GND (0 V) is applied to the pre-charge line PDL, depending on ON/OFF state. The pre-charge voltage at the time of pre-charge operation is the voltage HVDD (0.75 V). The power supply voltage VDD (1.5 V) and the ground voltage GND (0 V) are used for driving the sense amplifier 13. The power supply voltage VDD is a voltage that is used also in many logic circuits.

As described above, various kinds of operation voltages are necessary for operating the typical DRAM 10. The various kinds of operation voltages include not only positive voltages but also negative voltages. It should be noted that in a case of an SRAM, only the normal power supply voltage VDD and the ground voltage GND are used.

The inventor of the present application has recognized the following points. Since the memory cell of the DRAM is smaller than the memory cell of the SRAM, it is considered possible to reduce a chip area of the LCD driver IC by replacing the embedded SRAM with the embedded DRAM. However, as shown in FIG. 1, much more kinds of operation voltages are required in the case of the typical DRAM as compared with the case of the SRAM. It is thus necessary in the case of DRAM to add a DRAM-dedicated power supply that is different from a power supply for generating the normal power supply voltage VDD. In the case of SRAM, on the other hand, it is only necessary to provide the power supply for generating the normal power supply voltage VDD, and an SRAM-dedicated power supply is unnecessary.

Therefore, the chip area reduction effect can not be sufficiently achieved even if the embedded SRAM is simply replaced with the embedded DRAM. The area reduction effect with respect to the memory cell array is countered by the addition of the DRAM-dedicated power supply. In particular, as to capacity of the DRAM used for storing the display data in the liquid crystal display, about 2 to 4 MByte is enough, which is much smaller than a typical DRAM capacity (about 1 GByte). This means that an area ratio of power-supply-related circuits with respect to the memory cell array is relatively large. That is to say, when the DRAM-dedicated power supply is added, the chip area reduction effect is greatly undermined.

### SUMMARY

In one embodiment of the present invention, a display driver IC having an embedded DRAM is provided. That is to say, the display driver IC according to the one embodiment is provided with a built-in DRAM in which digital data corresponding to a display image is stored. The display driver IC is further provided with a power supply circuit generating a predetermined voltage and a driver circuit. The driver circuit converts the above-mentioned digital data into a gray-scale voltage by using the predetermined voltage and outputs the gray-scale voltage to a display panel.

According to the one embodiment, electric power is supplied to the embedded DRAM from the above-mentioned power supply circuit. In other words, the embedded DRAM operates by using at least a part of the predetermined voltages which are originally generated for use in the driver circuit. A voltage higher than the normal power supply voltage and required by the DRAM can be generated from a high voltage for use in the driver circuit. This can be said to be ingenuity peculiar to the display driver IC having the embedded DRAM. In this manner, the power supply circuit that is originally provided for use in display drive control is shared by the driver circuit and the embedded DRAM. Since it is not necessary to add a special power supply dedicated to the DRAM, the chip area reduction effect can be sufficiently achieved and a cost of manufacturing can also be reduced.

According to the present invention, it is possible to greatly reduce the chip area of the display driver IC provided with the memory for storing the display data.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a conceptual diagram showing a configuration of a typical DRAM and kinds of voltages used therein;

FIG. 2 is a block diagram showing a configuration of a display apparatus provided with a display driver IC according to a first embodiment of the present invention;

FIG. 3 is a graph showing one example of a relationship between gray-scales and gray--scale voltages;

FIG. 4 is a schematic block diagram for explaining supply of voltages with respect to an embedded DRAM according to the first embodiment;

FIG. 5 is a conceptual diagram showing a configuration of an embedded DRAM in a display driver IC according to a second embodiment of the present invention and kinds of voltages used therein; and

FIG. 6 is a schematic block diagram for explaining supply of voltages with respect to the embedded DRAM according to the second embodiment.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A display apparatus and a display driver IC according to embodiments of the present invention will be described with reference to the accompanying drawings. The display apparatus is exemplified by a liquid crystal display.

### 1. First Embodiment

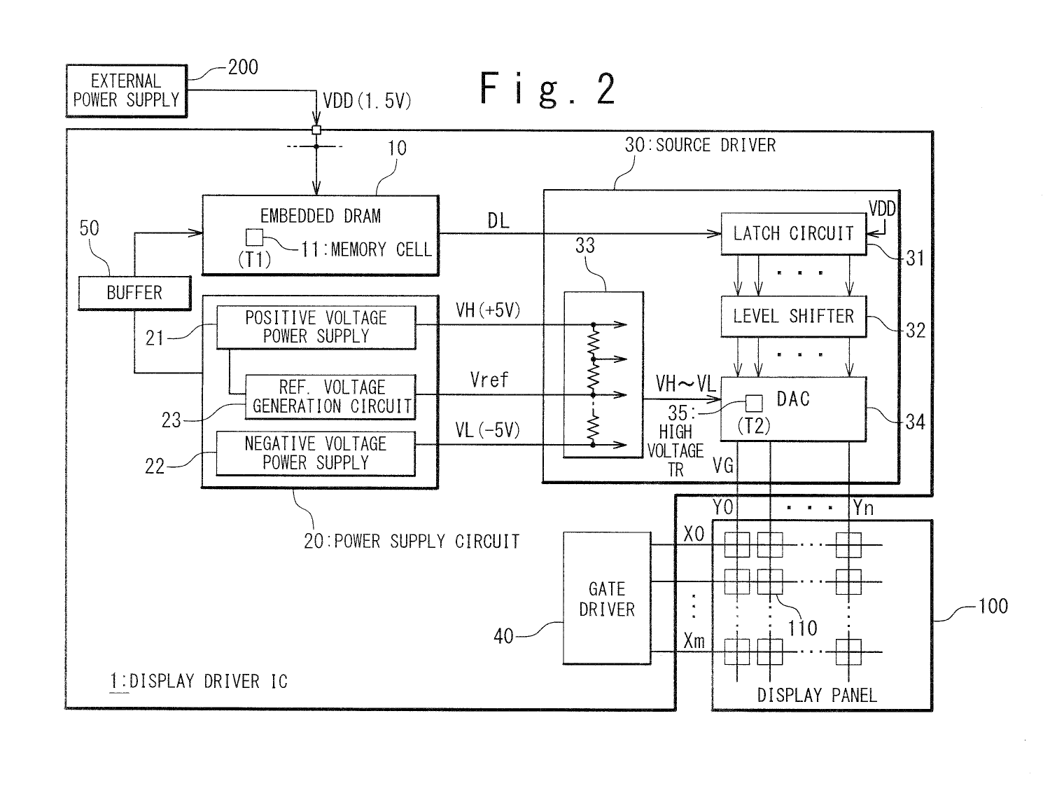

FIG. 2 is a block diagram showing a configuration of a display apparatus according to a first embodiment of the present invention. The display apparatus is provided with a display driver IC 1 and a display panel 100. The display driver IC 1 is an IC for controlling image display on the display panel 100 and is integrated on a single chip. A power supply voltage VDD (e.g. 1.5 V) is supplied to the display driver IC 1 from an external power supply 200.

The display panel 100 is an LCD panel, for example. The display panel 100 has a plurality of pixels 110 that are arranged in a matrix form. Also, a plurality of gate lines X0 to Xm and a plurality of source lines Y0 to Yn are so formed as to intersect with each other, and the pixels 110 are formed at respective intersections. Each of the pixels 110 includes a TFT (Thin Film Transistor), a liquid crystal element, and a common electrode. One end of the liquid crystal element is connected to the TFT, and the other end is connected to the common electrode to which a predetermined common voltage VCOM is applied.

One gate line X is connected to the pixels 110 of one line, and the display driver IC 1 applies gray-scale voltages (pixel voltages) corresponding to gray-scales of a display data simultaneously to the pixels 110 of one line through the source lines Y0 to Yn, respectively. The gate lines X0 to Xm are driven in order and thereby the image is displayed on the display panel 100. Here, a typical liquid crystal display employs an “inversion driving method” such as a frame inversion driving method, a line inversion driving method, or a dot inversion driving method, for the purpose of reducing flicker and suppressing deterioration of the liquid crystal element. According to the inversion driving method, a “polarity” of the pixel voltage applied to the pixel 110 is inverted every predetermined period, or the “polarity” is inverted between adjacent pixels 110. Here, the “polarity” indicates whether the pixel voltage is positive or negative with respect to the common voltage VCOM of the common electrode as a reference. That is, two kinds of gray-scale voltages, i.e. a positive-polarity gray-scale voltage and a negative-polarity gray-scale voltage are used with regard to one gray-scale.

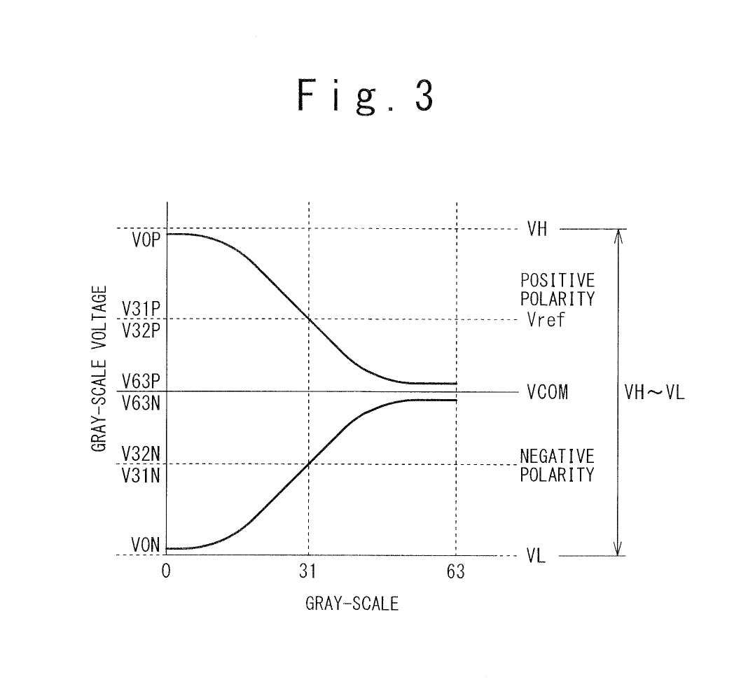

FIG. 3 shows one example of a relationship between gray-scales and gray-scale voltages (pixel voltages) in a case of 64-level gray-scale representation. With regard to the positive-polarity side, positive-polarity gray-scale voltages V0P to V63P are related to the 0th to 63rd gray-scales in this order. With regard to the negative-polarity side, on the other hand, negative-polarity gray-scale voltages V0N to V63N are related to the 0th to 63rd gray-scales in this order. In a case where the common voltage VCOM is a ground voltage, the positive-polarity gray-scale voltages V0P to V63P are positive voltages and within a positive voltage range VH to VCOM. On the other hand, the negative-polarity gray-scale voltages V0N to V63N are negative voltages and within a negative voltage range VCOM to VL. In the present embodiment, let us consider a case where both the positive voltage range VH to VCOM and the negative voltage range VCOM to VL are used.

Referring back to FIG. 2, the display driver IC 1 according to the present embodiment will be described below in detail.

The display driver IC 1 is provided with a DRAM 10. The DRAM 10 is used for storing display data that is digital data corresponding to an image to be displayed on the display panel 100. That is to say, the display driver IC 1 has the embedded DRAM 10 (DRAM macro) for use in storing the display data. The embedded DRAM 10 has a plurality of memory cells 11. Each memory cell 11 includes a cell transistor T1 and a cell capacitor. At least the power supply voltage VDD (1.5 V) is supplied to the embedded DRAM 10 from the external power supply 200.

The display driver IC 1 is further provided with a power supply circuit 20, a source driver 30 (driver circuit) and a gate driver 40 which are for use in display drive control.

The power supply circuit 20 is configured to output internal voltages that are used for generating the gray-scale voltages (pixel voltages) applied to the pixels 110. In the present embodiment, the positive voltage range VH to VCOM and the negative voltage range VCOM to VL as shown in FIG. 3 are used as the gray-scale voltages. For that purpose, the power supply circuit 20 includes a positive voltage power supply 21 that generates the positive voltage VH and a negative voltage power supply 22 that generates the negative voltage VL. The power supply circuit 20 may further include a reference voltage generation circuit 23 that generates a positive reference voltage Vref (<VH) based on the positive voltage VH. An upper limit of the absolute values of the gray-scale voltages is larger than the power supply voltage VDD (1.5 V). For example, the positive voltage VH and the negative voltage VL are +5 V and −5 V, respectively. In this manner, the power supply circuit 20 generates the high voltages VH and VL that are larger than the power supply voltage VDD. The high voltages VH, VL and the reference voltage Vref are supplied to the source driver 30.

The source driver 30 receives a display data DL for one line from the embedded DRAM 10. Then, the source driver 30 converts the display data DL into the corresponding gray-scale voltages VG, and outputs the gray-scale voltages (pixel voltages) VG to the display panel 100 through the source lines Y0 to Yn. More specifically, the source driver 30 includes a latch circuit 31, a level shifter 32, a gray-scale voltage generation circuit 33 and a DA converter 34.

The latch circuit 31 latches the display data DL for one line. The display data DL is supplied to the DA converter 34 through the level shifter 32. Meanwhile, the gray-scale voltage generation circuit 33 receives the positive voltage VH (+5 V), the negative voltage VL (−5 V) and the reference voltage Vref from the power supply circuit 20. The gray-scale voltage generation circuit 33 has a plurality of voltage divider resistors that are connected in series, and generates a plurality kinds of gray-scale voltages through the voltage division based on references including the positive voltage VH, the negative voltage VL, the reference voltage Vref and the like. The plurality kinds of gray-scale voltages are the positive-polarity gray-scale voltages V0P to V63P and the negative-polarity gray-scale voltages V0N to V63N shown in FIG. 3, which are within a voltage range from VH to VL. The gray-scale voltage generation circuit 33 outputs the plurality kinds of gray-scale voltages to the DA converter 34. Based on the plurality kinds of gray-scale voltages, the DA converter 34 outputs the gray-scale voltages corresponding to the received display data DL. In this manner, the source driver 30 converts the display data DL into the corresponding gray-scale voltages by using the voltage range VH to VL that is defined by the positive voltage VH and the negative voltage VL. The output gray-scale voltages are applied as the pixel voltages VG to the pixels 110 of the display panel 100.

Since the source driver 30 needs to handle the high voltages VH and VL that are larger than the power supply voltage VDD, the source driver 30 has a high voltage element 35. For example, an output stage of the DA converter 34 for outputting the gray-scale voltage VG is comprised of a high voltage transistor T2.

The gate driver 40 is connected to the gate lines X0 to Xm and drives the gate lines X0 to Xm in order.

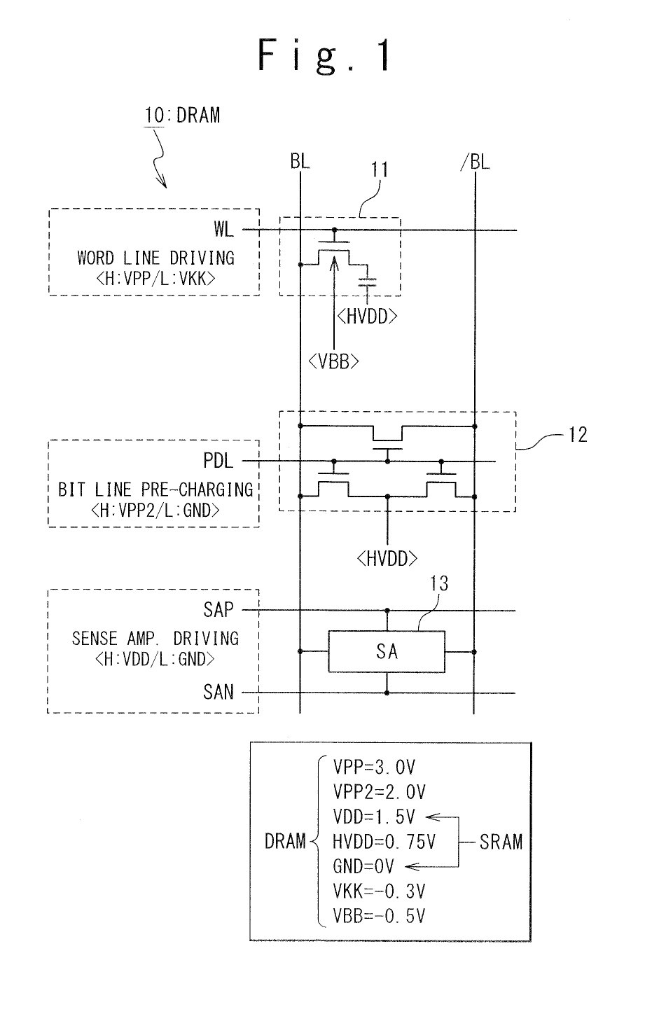

The embedded DRAM 10 according to the present embodiment is a typical DRAM shown in FIG. 1, which requires the various kinds of operation voltages (VPP, VPP2, VDD, HVDD, GND, VKK and VBB). However, a special power supply dedicated to the embedded DRAM 10 is not provided within the display driver IC 1. Instead, the above-mentioned power supply circuit 20 for use in the display drive control is utilized as the power supply with respect to the embedded DRAM 10 as well. In other words, at least a part of the power supply circuit 20 is shared by the embedded DRAM 10 and the source driver 30. For that purpose, the embedded DRAM 10 is connected to the power supply circuit 20 through a buffer circuit 50. Electric power is supplied to the embedded DRAM 10 from the power supply circuit 20 through the buffer circuit 50. The embedded DRAM 10 does not include an internal voltage generation circuit (voltage regulator, voltage booster, or voltage down converter) that boosts or lowers a voltage.

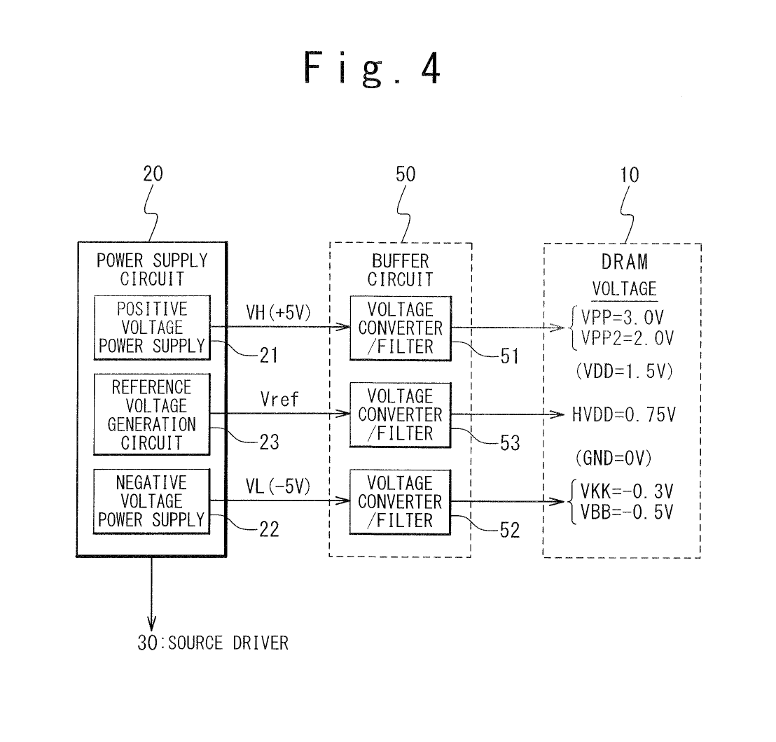

FIG. 4 is a schematic block diagram for explaining the supply of the voltages with respect to the embedded DRAM 10. As described above, the positive voltage power supply 21 outputs the positive voltage VH (+5 V). The reference voltage generation circuit 23 outputs the positive reference voltage Vref. The negative voltage power supply 22 outputs the negative voltage (−5 V). The power supply voltage VDD (1.5 V) among the operation voltages used by the embedded DRAM 10 is supplied from the external power supply 200. The other positive operation voltages are generated from the positive voltage VH (+5.0 V) output by the positive voltage power supply 21. If there is an appropriate reference voltage Vref, the reference voltage Vref may be utilized for generating a positive operation voltage. On the other hand, the negative operation voltages are generated from the negative voltage VL (−5.0 V) output by the negative voltage power supply 22.

For example, a buffer circuit 51 converts the positive voltage VH (+5.0 V) into the operation voltages VPP (3.0 V) and VPP2 (2.0 V) of the embedded DRAM 10. A buffer circuit 53 converts the reference voltage Vref into the operation voltage HVDD (0.75 V) of the embedded DRAM 10. A buffer circuit 52 converts the negative voltage VL (−5.0 V) into the operation voltages VKK (−0.3 V) and VBB (−0.5 V) of the embedded DRAM 10. It should be noted that the buffer circuit 50 serves as not only the voltage conversion circuit but also a filter for suppressing propagation of noises.

As described above, the embedded DRAM 10 operates by the use of the voltages VH and VL that are originally generated for the source driver 30. Conversely, the positive voltages higher than the power supply voltage VDD and the negative voltages which are required by the embedded DRAM 10 can be generated from the high voltages VH and VL for use in the source driver 30. This can be said to be ingenuity peculiar to the display driver IC 1 having the embedded DRAM 10.

According to the present embodiment, the embedded DRAM 10 is used as an embedded memory for storing the display data. As a result, a chip area is reduced as compared with the case of an embedded SRAM. Furthermore, it is not necessary to add a special power supply dedicated to the embedded DRAM 10. Therefore, the chip area reduction effect can be sufficiently achieved and a cost of manufacturing can also be reduced. In particular, as to capacity of a memory used for storing the display data in the liquid crystal display, about 2 to 4 MByte is enough, which is much smaller than a typical DRAM capacity (about 1 GByte). This means that an area ratio of power-supply-related circuits with respect to the memory cell array is relatively large. It is therefore possible to greatly reduce the chip area by eliminating a special power supply dedicated to the embedded DRAM.

In the example shown in FIG. 4, the embedded DRAM 10 uses both of the positive voltage power supply 21 and the negative voltage power supply 22 as the power supply. However, the embedded DRAM 10 may use only any one of the positive voltage power supply 21 and the negative voltage power supply 22. In a case where only the positive voltage power supply 21 is shared by the embedded DRAM 10, a positive voltage power supply dedicated to the embedded DRAM 10 can be eliminated. On the other hand, in a case where only the negative voltage power supply 22 is shared by the embedded DRAM 10, a negative voltage power supply dedicated to the embedded DRAM 10 can be eliminated. In any case, the chip area reduction effect can be obtained.

It should be noted that the cell transistor T1 in the embedded DRAM 10 that handles the voltages higher than the power supply voltage VDD needs to be formed to be a high voltage transistor. Here, the same one as the high voltage transistor T2 within the source driver 30 can be used as the cell transistor T1. That is to say, it is possible to design a breakdown voltage of the cell transistor T1 to be equal to a breakdown voltage of the high voltage transistor T2. In this case, both of the cell transistor T1 in the memory cell and the high voltage transistor T2 required in the source driver 30 can be fabricated through the same process. As a result, a structure of the cell transistor T1 can be the same as that of the high voltage transistor T2. Consequently, the kinds of the transistors are decreased, and the number of manufacturing processes is reduced. This can also be said to be ingenuity peculiar to the display driver IC 1 having the embedded DRAM 10.

### 2. Second Embodiment

The above-described negative operation voltages VKK (−0.3 V) and VBB (−0.5 V) are used for reducing the off-leakage current in the memory cell 11. However, a means for reducing the off-leakage current is not limited to the application of the negative voltages VKK and VBB. For example, the cell transistor T1 within the memory cell 11 may be formed with a transistor that has a high threshold voltage. It should be noted here that the display driver IC 1 is provided with the high voltage transistor T2 having a high threshold voltage within the source driver 30. Therefore, when the DRAM 10 is embedded in the display driver IC 1, it is possible to fabricate the cell transistor T1 and the high voltage transistor T2 through the same process. In this case, it is possible to reduce the off-leakage current without using the negative voltages VKK and VBB.

According to the second embodiment of the present invention, a DRAM which does not use the negative voltages VKK and VBB is embedded in the display driver IC 1.

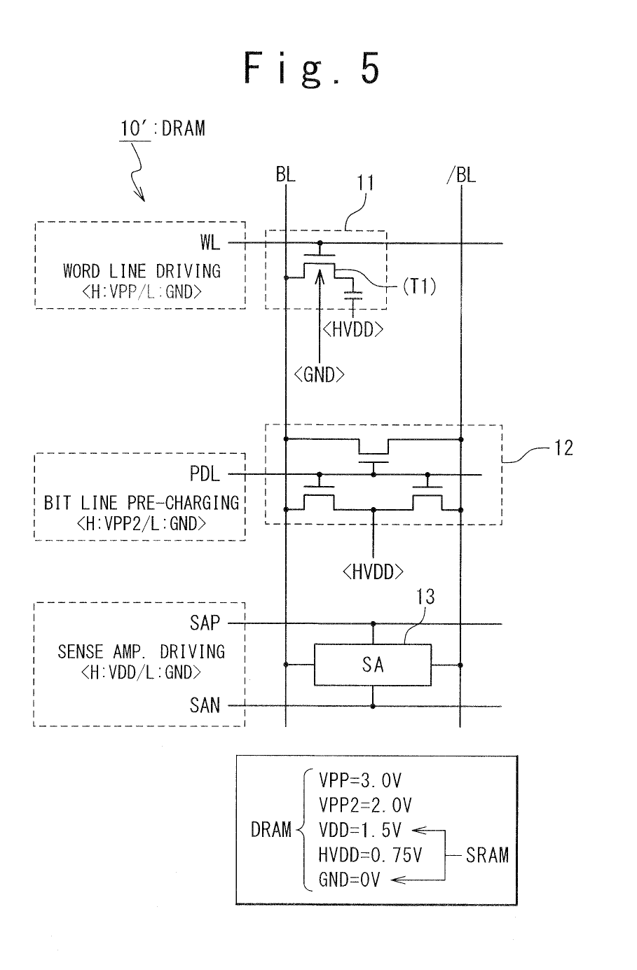

FIG. 5 shows a configuration of an embedded DRAM 10′ and kinds of voltages used therein according to the present embodiment. The same reference numerals are given to the same components as those described in the first embodiment, and an overlapping description will be omitted as appropriate. As shown in FIG. 5, the ground voltage GND instead of the negative voltage VKK is applied to the word line WL in the embedded DRAM 10′. Moreover, the ground voltage GND instead of the negative voltage VBB is applied to the back gate of the cell transistor T1. That is to say, the DRAM 10′ according to the present embodiment is configured to operate only with the positive operation voltages (VPP, VPP2, VDD and HVDD) and the ground voltage GND. Therefore, at least a negative voltage power supply dedicated to the embedded DRAM 10′ becomes unnecessary. As a result, the chip area reduction effect can be obtained at minimum.

The same one as the high voltage transistor T2 within the source driver 30 can be used as the cell transistor T1. That is to say, it is possible to design a breakdown voltage of the cell transistor T1 to be equal to a breakdown voltage of the high voltage transistor T2. In this case, both of the cell transistor T1 in the memory cell 11 and the high voltage transistor T2 required in the source driver 30 can be fabricated through the same process. As a result, a structure of the cell transistor T1 can be the same as that of the high voltage transistor T2. Consequently, the kinds of the transistors are decreased, and the number of manufacturing processes is reduced. Since a threshold voltage of the cell transistor T1 becomes sufficiently high, the off-leakage current in the memory cell 11 can be reduced sufficiently even if the negative voltages VBB and VKK are not applied. This can be said to be ingenuity peculiar to the display driver IC 1 having the embedded DRAM 10.

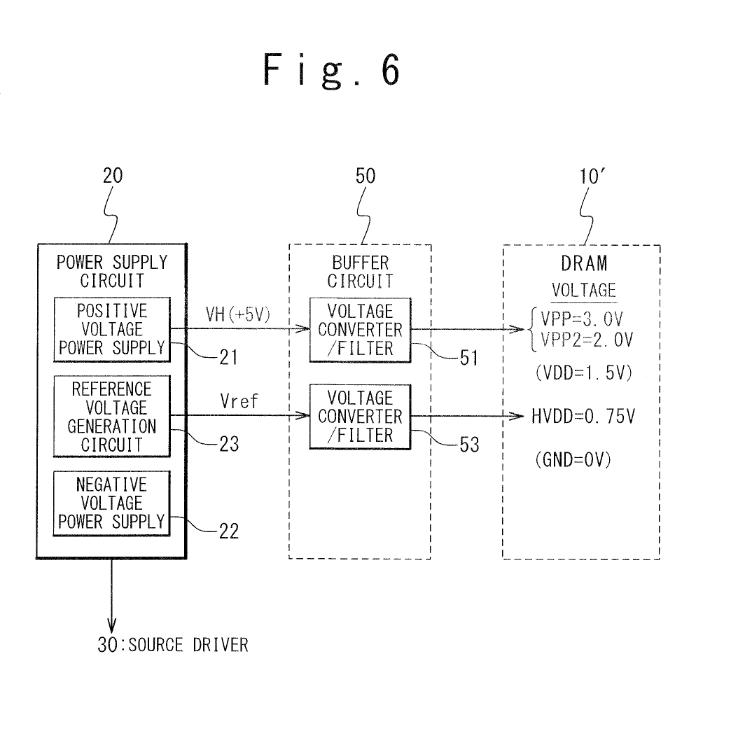

Furthermore, as in the first embodiment, electric power is supplied to the embedded DRAM 10′ from the power supply circuit 20 through the buffer circuit 50. The embedded DRAM 10′ does not include an internal voltage generation circuit (voltage regulator, voltage booster, or voltage down converter) that boosts or lowers a voltage. FIG. 6 is a schematic block diagram for explaining the supply of the voltages with respect to the embedded DRAM 10′. The power supply voltage VDD (1.5 V) among the operation voltages used by the embedded DRAM 10′ is supplied from the external power supply 200. The other positive operation voltages are generated from the positive voltage VH (+5.0 V) output by the positive voltage power supply 21. If there is an appropriate reference voltage Vref, the reference voltage Vref may be utilized for generating a positive operation voltage. For example, the buffer circuit 51 converts the positive voltage VH (+5.0 V) into the operation voltages VPP (3.0 V) and VPP2 (2.0 V) of the embedded DRAM 10′. The buffer circuit 53 converts the reference voltage Vref into the operation voltage HVDD (0.75 V) of the embedded DRAM 10′.

As described above, the embedded DRAM 10′ operates by the use of the positive voltage VH that is originally generated for the source driver 30. Conversely, the positive operation voltages higher than the power supply voltage VDD which are required by the embedded DRAM 10′ can be generated from the high voltage VH for use in the source driver 30. The embedded DRAM 10′ does not require any negative operation voltage, and moreover it is not necessary to add a positive voltage power supply dedicated to the embedded DRAM 10′. As a result, it is possible to greatly reduce the chip area and the cost of manufacturing.

When the threshold voltage of the cell transistor T1 is increased, it may become necessary to set the driving voltage VPP of the word line WL to be still higher as well. For example, the driving voltage VPP of +5 V may be required. Such the high driving voltage VPP can also be covered by the positive voltage VH (+5.0 V) that is output by the existing positive voltage power supply 21. It is unnecessary to enlarge a scale of the power supply circuit 20.

It is apparent that the present invention is not limited to the above embodiments and may be modified and changed without departing from the scope and spirit of the invention.

What is claimed is:

1. A display driver IC for controlling display of an image on a display panel, comprising:
a DRAM in which digital data corresponding to said image is stored;
a power supply circuit configured to generate a predetermined voltage; and
a driver circuit configured to convert said digital data into a gray-scale voltage by using said predetermined voltage and to output said gray-scale voltage to said display panel,
wherein electric power is supplied to said DRAM from said power supply circuit.

2. The display driver IC according to claim 1,
wherein said power supply circuit includes:
a positive voltage power supply configured to generate a positive voltage; and
a negative voltage power supply configured to generate a negative voltage,
wherein said driver circuit converts said digital data into said gray-scale voltage by using a voltage range defined by said positive voltage and said negative voltage,
wherein said DRAM uses at least one of said positive voltage power supply and said negative voltage power supply as a power supply.

3. The display driver IC according to claim 2,
wherein said DRAM uses both of said positive voltage power supply and said negative voltage power supply as a power supply.

4. The display driver IC according to claim 1,
wherein said DRAM is configured to operate with not only a power supply voltage and a ground voltage that are supplied from an external power supply but also an operation voltage other than said power supply voltage and said ground voltage,
wherein said operation voltage is generated from said predetermined voltage output by said power supply circuit.

5. The display driver IC according to claim 1,
wherein said DRAM does not include a voltage generation circuit that boosts or lowers a voltage.

6. The display driver IC according to claim 1,
wherein a memory cell of said DRAM has a first transistor and said driver circuit has a second transistor configured to output said gray-scale voltage,
wherein a breakdown voltage of said first transistor is equal to a breakdown voltage of said second transistor.

7. The display driver IC according to claim 6,
wherein said first transistor has a same structure as said second transistor.

8. A display driver IC for controlling display of an image on a display panel, comprising:
a DRAM in which digital data corresponding to said image is stored; and
a driver circuit configured to convert said digital data into a gray-scale voltage and to output said gray-scale voltage to said display panel,
wherein said DRAM operates only with positive voltages and a ground voltage.

9. The display driver IC according to claim 8,
wherein a memory cell of said DRAM has a first transistor and said driver circuit has a second transistor configured to output said gray-scale voltage,
wherein said first transistor has a same structure as said second transistor.

10. The display driver IC according to claim 8, further comprising a power supply circuit configured to generate a predetermined voltage,
wherein said driver circuit converts said digital data into said gray-scale voltage by using said predetermined voltage,
wherein electric power is supplied to said DRAM from said power supply circuit.

11. The display driver IC according to claim 10,
wherein said positive voltages include not only a power supply voltage supplied from an external power supply but also a positive operation voltage that is different from said power supply voltage,
wherein said positive operation voltage is generated from said predetermined voltage output by said power supply circuit.

12. The display driver IC according to claim 10,
wherein said DRAM does not include a voltage generation circuit that boosts or lowers a voltage.
